(19) United States
(12) Patent Application Publication
(10) Pub. No.: US 2024/0428524 A1
(43) Pub. Date: Dec. 26, 2024

(54) INFORMATION PROCESSING SYSTEM, INFORMATION PROCESSING METHOD, AND PROGRAM

(71) Applicant: VRC Inc., Tokyo (JP)

(72) Inventors: Yingdi XIE, Tokyo (JP); Yanpeng Zhang, Tokyo (JP); Yujia Liu, Tokyo (JP); Michihisa Iguchi, Tokyo (JP)

(21) Appl. No.: 18/748,209

(22) Filed: Jun. 20, 2024

(30) Foreign Application Priority Data
Jun. 23, 2023 (JP) 2023-103502

(51) Int. Cl. G06T 19/00

(52) U.S. Cl. CPC G06T 19/00

(57) ABSTRACT

An information processing system includes: at least one processor; and a memory operably connected to the at least one processor, wherein the at least one processor is configured to: acquire an image of a user; generate a 3D avatar from the acquired image; receive an instruction to generate content including the 3D avatar and a virtual space; generate the content in response to the instruction; convert the content into data for use in the virtual space, and data for manufacturing products for use in a real space; output data for use of the content in the virtual space; and output data to a device that manufactures the products for use in the real space.

### FIELD

The present disclosure relates to technology for utilizing 3D data.

### RELATED ART

Known in the art are technologies for utilizing various types of data both in real and virtual spaces. For example, JP 2000-115811A discloses a technique for creating three-dimensional photographic images on a lenticular sheet, while JP 2023-045813A discloses a method for taking a picture with a virtual camera in a virtual space, and more particularly, for taking a picture of a subject to which an effect is added in a game.

### SUMMARY

In view of the background described above, the present disclosure provides users with services for utilizing various types of 3D data in a combination of virtual and real spaces.

One aspect of the present disclosure provides: an information processing system including: at least one processor; and a memory operably connected to the at least one processor, wherein the at least one processor is configured to: acquire an image of a user; generate a 3D avatar from the acquired image; receive an instruction to generate content including the 3D avatar and a virtual space; generate the content in response to the instruction; convert the content into data for use in the virtual space, and data for manufacturing products for use in a real space; output data for use of the content in the virtual space; and output data to a device that manufactures the products for use in the real space.

The instructions may include an instruction to change a position, posture, or movement of the 3D avatar.

The instructions may include an instruction to change a viewpoint in the virtual space.

The instructions include an instruction to include in the content, at least one content component that is additional to the 3D avatar and the virtual space.

The additional content component may include background images, objects, or a 3D avatar of another user.

The manufactured product may includes a lenticular sheet on which an image showing the generated content is formed, and the at least one processor may be further configured to output to the device the data for forming on the lenticular sheet the image showing the generated content.

The at least one processor may be further configured to output to the device data to form on the manufactured product image code for accessing the content in the virtual space.

The at least one processor may be further configured to modify the content in accordance with error information for the manufactured product, the error information being input from the device.

Another aspect of the present disclosure provides: an information processing method including: acquiring an image of a user; generating a 3D avatar from the acquired image;

receiving an instruction to generate content including the 3D avatar and a virtual space; generating the content in response to the instruction; converting the content into data for use in the virtual space and into data for manufacturing products for use in a real space; outputting data for use of the content in the virtual space; and outputting data to a device that manufactures products for use of the content in the real space.

Yet another aspect of the present disclosure provides: a computer-readable non-transitory storage medium for storing a program that causes a computer to execute a process, the process including: acquiring an image of a user; generating a 3D avatar from the image; receiving an instruction to generate content including the 3D avatar and a virtual space; generating the content in response to the instruction; converting the content into data for use in the virtual space and data for manufacturing products for use in a real space; outputting data for use of the content in the virtual space; and outputting data to a device that manufactures the products for use of the content in the real space.

### BRIEF DESCRIPTION OF THE DRAWINGS

FIG. 1 is an illustrative overview of information processing system 1.

FIG. 2 shows an example configuration of information processing system 1.

FIG. 3 shows an example of a functional configuration of information processing system 1.

FIG. 4 shows an example of a hardware configuration of 3D scanner 10.

FIG. 5 shows an example of a hardware configuration of server 20.

FIG. 6 shows an example of a hardware configuration of manufacturing device 30.

FIG. 7 shows an example of a hardware configuration of user terminal 40.

FIG. 8 shows a sequence chart illustrating an example of content generation in information processing system 1.

FIG. 9 shows an example of the content.

FIG. 10 shows a sequence chart illustrating content use and product manufacture in information processing system 1.

FIG. 11 shows an example of a manufactured product.

FIG. 12 illustrates production and use of a stereoscopic sheet.

FIG. 13 illustrates visual effects in a lenticular sheet.

FIG. 14 shows a sequence chart illustrating an error detection method for a lenticular sheet in information processing system 1.

FIG. 15 shows an example of a lenticular lens.

FIG. 16 shows an example of a lenticular sheet database.

### DETAILED DESCRIPTION

### 1. Configuration

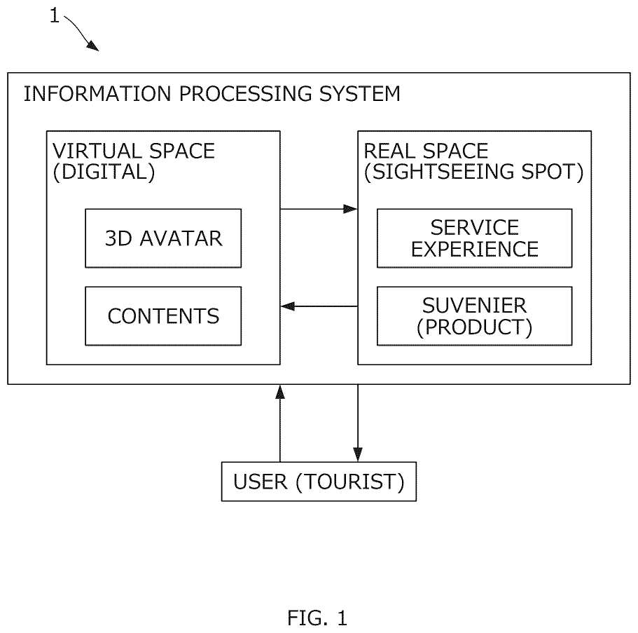

FIG. 1 shows an illustrative overview of information processing system 1. In this example, an information processing system 1 refers generally to a system that utilizes 3D data to provide services to a tourist (an example of a user) at a sightseeing spot. In this example, the services include a combination of experiences in areal space, such as provision of services at the sightseeing spot and buying souvenirs (an example of manufactured products), and experiences in a virtual space, such as use of the user's 3D avatar and content. More specifically, the virtual space is a metaverse where the sightseeing spot is reproduced, and where the user's 3D avatar can explore and engage in sightseeing and various other activities while being recorded. The services in the virtual space interact with the services in the real space to provide the user with a novel service. Thus, one of the objectives of information processing system 1 is to provide users with a novel service in which the virtual and real space are combined using various types of 3D data.

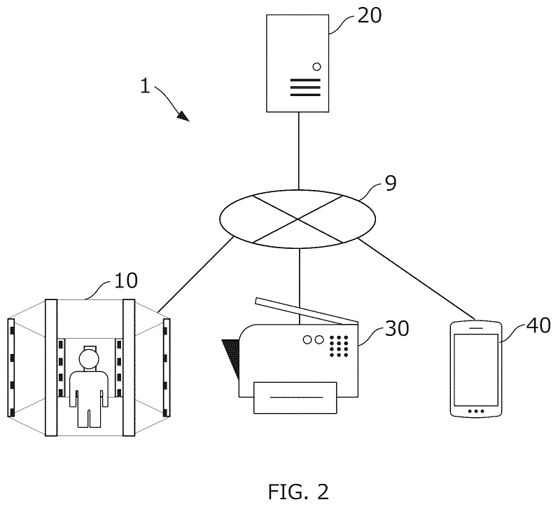

FIG. 2 shows an example of a configuration of information-processing system 1. In this embodiment, information-processing system 1 includes a 3D scanner 10, a server 20, a manufacturing device 30, and a user terminal 40. The components of the system are connected via a network 9, which is a computer network such as the Internet. Of these devices, 3D scanner 10 and manufacturing device 30 are installable at the sightseeing spot.

In this embodiment, 3D scanner 10 is an information-processing device/image processing device that is used to acquire 3D data of a user. The 3D data represents a 3D model of the user, and includes information about a three-dimensional appearance, such as a geometry, skin texture, and skin condition/color of the user. To acquire this information, 3D scanner 10 captures images of the user by way of a photographic device, and acquires color (RGB) data and distance data. Based on the acquired data, 3D scanner 10 generates a 3D avatar (an example of 3D data) of the user.

In this embodiment, server 20 is an information-processing device/general purpose server that uses the user's 3D avatar to generate, manage, and edit content in the virtual space. In this example, in addition to the user's 3D avatar, the content includes a metaverse and objects at a sightseeing spot. In other words, server 20 provides content for use by the user in both the virtual and real space.

In this embodiment, manufacturing device 30 is a device for manufacturing a product such as souvenirs sold at a sightseeing spot, based on the content provided by server 20. The manufactured product may be a complete product, a part-finished product, or a component of the product. By use of the content in combination with the manufactured product, at least part of the service experienced by the user in the virtual space is reproduced as a physical object in the real space. Examples of the manufactured product include, for example, a customized stereoscopic sheet (or lenticular sheet), a crystal etching, and a figurine, which are sold as souvenirs at the sightseeing spot.

In this embodiment, user terminal 40 is a terminal device (or terminal) used by a user. The user uses the terminal device to access various services. User terminal 40 operates in conjunction with server 20 and manufacturing device 30 to use the user's 3D avatar, control generation and editing of the content, and manage manufacture of the manufactured product.

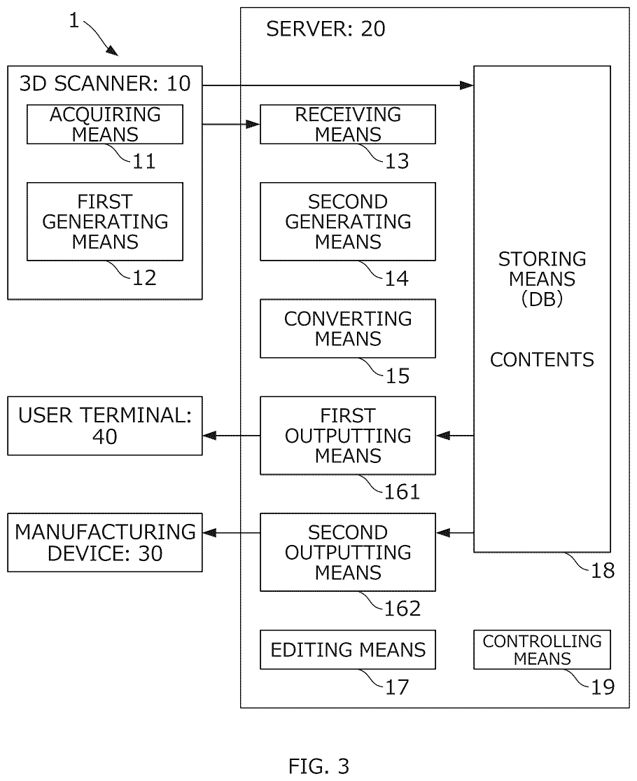

FIG. 3 shows an example of a functional structure of information-processing system 1. In this embodiment, information-processing system 1 includes acquiring means 11, first generating means 12, receiving means 13, second generating means 14, converting means 15, first outputting means 161, second outputting means 162, editing means 17, storing means 18, and controlling means 19. In this example, storing means 18 stores various types of data, including, for example, a database. Controlling means 19 performs various types of control. Acquiring means 11 and first generating means 12 are implemented in 3D scanner 10. Receiving means 13, second generating means 14, converting means 15, first outputting means 161, second outputting means 162, editing means 17, storing means 18, and controlling means 19 are implemented in server 20.

Acquiring means 11 acquires the user's image. For example, acquiring means 11 captures an image of the user by way of the photographic device installed in 3D scanner 10, and acquires color (RGB) data and distance data.

First generating means 12 generates the 3D avatar from the user's image. In this example, first generating means 12 generates the 3D avatar of the user based on the acquired color data and distance data.

Receiving means 13 receives an instruction to generate the content including the 3D avatar and the virtual space. In this example, the instruction includes, for example, an instruction to change any of the position, posture, or movement of the 3D avatar.

Responsive to the received instruction, second generating means 14 generates the content. More specifically, second generating means 14 generates, for example, the user's 3D avatar posing for fun in the virtual space that reproduces the sightseeing spot. The generated content is recorded as data in storing means 18.

Converting means 15 converts the content into data for use in the virtual space and into data for manufacturing the product for use in the real space.

First outputting means 161 outputs data to the user terminal 40 for use of the content in the virtual space. The user can use the user terminal 40 to access the output data and replay the content, i.e., look back on memories, or share the content, i.e., share the output data with his/her friends.

Second outputting means 162 outputs the data to manufacturing device 30 for manufacturing the product. In this example, the manufactured product includes any of the complete product, part-finished product, or component of the product for use in the real space. More specifically, the manufactured product includes, for example, any of the customized stereoscopic sheet (or lenticular sheet), crystal etching, or figurine. In this example, the stereoscopic sheet is a print sheet that includes a laminated lenticular lens on which an image is formed. When viewed by the user from differing angles, the formed image appears to change and a three-dimensional effect is obtained. A crystal etching is an object on which letters or designs are formed on a front or rear of glass (crystal). More particularly, a 2D/3D crystal is crystal glass on which letters or designs are engraved by a laser. The figurine is a 3D object modeled from a drawing, such as a figure, a pattern, or a blueprint. These manufactured products are sold at, for example, the sightseeing spot.

Editing means 17 edits the content in response to product error information input from manufacturing device 30. The edited content is recorded as data in storing means 18.

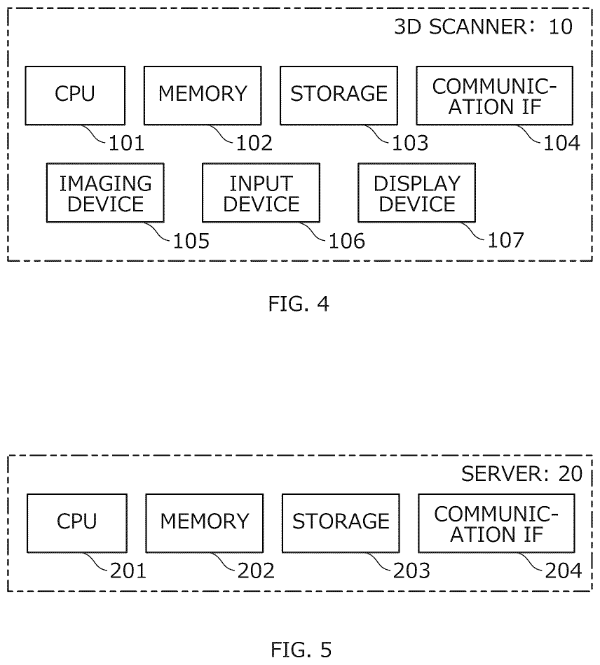

FIG. 4 shows an example of a hardware configuration of 3D scanner 10. In this example, 3D scanner 10 (is a computer or a scanner device) is a 3d scanning device that includes CPU (Central Processing Unit) 101, memory 102, storage 103, communication IF 104, and display device 107. CPU 101 is a processor that performs various processes in accordance with a program. Memory 102 is a main memory device that serves as a work area when CPU 101 executes a program, and includes RAM (Random Access Memory), for example. Storage 103 is an auxiliary storage device that stores various data and programs, and includes an SSD (Solid State Drive) or an HDD (Hard Disc Drive), for example. Communication IF 104 is a device that communicates with other devices in accordance with a predetermined communication standard, and includes, for example, a Network Interface Card (NIC).

Imaging device 105 is a device for capturing images of the user, and includes a RGB camera and a distance sensor for acquiring 3D image data. Input device 106 is a device for inputting information into 3D scanner 10, including, for example, a touch screen (touch panel), a keyboard, a mouse, or a pointing device. Display device 107 is a device that displays information and includes, for example, an OLED (Electro Luminescence) display or a liquid crystal display. 3D scanner 10 includes an image-capture space (room) for accommodating the user for image capture of the user. Installed in the image-capture space (room), are cameras and sensors, which are examples of imaging device 105, and a display, which is an example of display device 107.

Programs stored in storage 103 include a program (hereinafter, “control program 10”) that causes a computer to function as 3D scanner 10 in information processing system 1. When CPU 101 is executing the control program, CPU 101, memory 102, storage 103, imaging device 105, input device 106, and display device 107 are examples of elements used for operation of 3D scanner 10. CPU 101 is an example of first generating means 12. Imaging device 105 is an example of acquiring means 11.

FIG. 5 shows an example of a hardware configuration of server 20. In this example, server 20 is a computer or general-purpose server that includes CPU 201, memory 202, storage 203, and communication IF 204. CPU 201 is a processor that performs various processes in accordance with a program. Memory 202 is a main memory that serves as a work area when CPU 201 executes a program, and includes RAM, for example. Storage 203 is an auxiliary storage device that stores various data and programs and includes, for example, an SSD or an HDD. Communication IF 204 is a device that communicates with other devices in accordance with a predetermined communication standard, and includes, for example, a NIC.

Programs stored in storage 203 include a program (hereinafter, the “server program”) that cause a computer to act as server 20 in information processing system 1. When CPU 201 is executing the server program, CPU 201, memory 202, storage 203, and communication IF 204 are examples of elements used for operation of server 20. CPU 201 is an example of second generating means 14, converting means 15, editing means 17, and controlling means 19. At least one of memory 202 and storage 203 is an example of storing means 18. Communication IF 204 is an example of receiving means 13, first outputting means 161, and second outputting means 162.

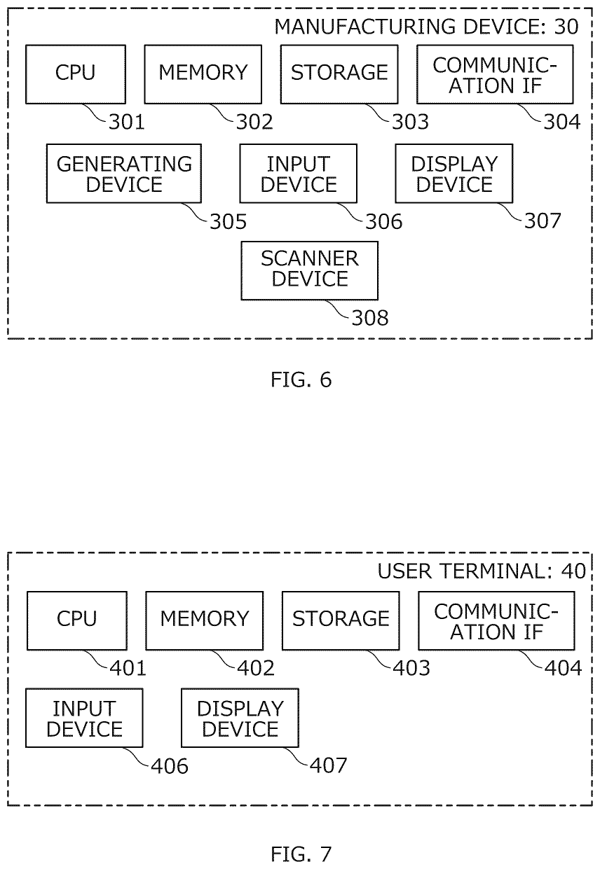

FIG. 6 shows an example of a hardware configuration of manufacturing device 30. In this example, manufacturing device 30 is an imaging device that includes CPU 301, communication IF 304, generating device 305, and display device 307, and also includes, for example, a printer, a 3D printer and/or an etching device. CPU 301 is a processor that performs various processes in accordance with a program. Memory 302 is a main memory that serves as a work area when CPU 301 executes a program, and includes a RAM, for example. Storage 303 is an auxiliary storage device that stores various data and programs, and includes, for example, an SSD or an HDD. Communication IF 304 is a device that communicates with other devices in accordance with a predetermined communication standard, and includes, for example, a chip for wireless communication.

Generating device 305 is a device that includes a printing unit, a modelling unit, and a processing unit that operate in accordance with a product to be manufactured. In a case that the manufactured product includes a lenticular sheet, the printing unit prints and forms a composite image on the lenticular lens of the sheet to generate a product. Generating device 305 can also retrieve content from server 20 for manufacture of a product that includes an image, for example.

Input device 306 is a device for inputting information into manufacturing device 30, and includes, for example, a touch screen (touch panel), a keyboard, a mouse, or a pointing device. Display device 307 is a device that displays information, and includes, for example, an OLED or LCD screen. Scanner device 308 is a device for scanning a lenticular sheet, for example, to detect errors in the lenticular sheet.

Programs stored in storage 303 include a program (hereinafter, “control program 30”) that cause a computer to act as manufacturing device 30 in information processing system 1. When CPU 301 is executing the control program, CPU 301, memory 302, storage 303, communication IF 304, generating device 305, input device 306, display device 307, and scanner device 308 are examples of elements used for operation of manufacturing device 30.

FIG. 7 shows an example of a hardware configuration of user terminal 40. In this example, user terminal 40 is a smartphone, a tablet, or a personal computer, and includes CPU 401, memory 402, storage 403, communication IF 404, input device 405, and display device 406. CPU 401 is a processor that performs various processes in accordance with a program. Memory 402 is a main memory that serves as a work area when CPU 401 executes a program, and includes a RAM, for example. Storage 403 is an auxiliary storage device that stores various data and programs, and includes, for example, an SSD or an HDD. Communication IF 404 is a device that communicates with other devices in accordance with a predetermined communication standard, and includes, for example, a chip for wireless communication. Input device 405 is a device for inputting information into the user terminal 40, and includes, for example, a touch screen, a keyboard, a mouse, or a pointing device. Display device 406 is a device that displays information and includes, for example, an OLED or an LCD screen.

User terminal 40 is capable of operating a device for use of content in the virtual space, for example, a metaverse, VR (Virtual Reality)/AR (Augmented Reality)/MR (Mixed Reality), and/or applications and the like. The device includes, for example, a VR headset, a VR goggle, or smart glasses. In this example, input device 405 includes a VR controller. Display device 406 includes a head-mounted display or a general-purpose display.

Programs stored in storage 403 include a act (hereinafter referred to as the “client program”) that causes a computer to function as a client in information processing system 1. When CPU 401 is executing the client program, CPU 401, memory 402, storage 403, communication IF 404, input device 405, and display device 406 are examples of elements for operating user terminal 40. The configuration of information processing system 1 has been described so far. Operation of information processing system 1 will be described below.

### 2. Operation

### 2-1. Content Generation

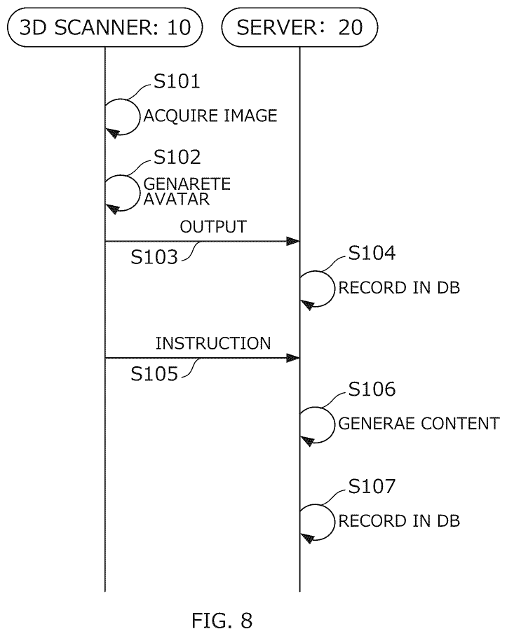

FIG. 8 shows a sequence chart illustrating a process for generating content in information processing system 1. At step S101, 3D scanner 10 captures an image of the user. In this example, 3D scanner 10 captures an image of the user using imaging device 105 installed in the 3D scanner. Imaging device 105 acquires a 2D image (e.g., RGB data) and distance data (or depth data). 3D scanner 10 uses this data to generate data for a 3D model data of the user.

At step S102, 3D scanner 10 generates 3D data that represents the user's 3D avatar. In this example, 3D scanner 10 generates the 3D avatar of the user based on the 2D image and distance data acquired from the image captured of the user. 3D scanner 10 generates the 3D data that represents the user's 3D geometry, skin texture, etc., from the acquired 2D image data and distance data.

At step S103, server 20 acquires the 3D data from 3D scanner 10. In this example, 3D scanner 10 outputs to server 20 3D data that represents the user's 3D avatar. With regard to the operations carried out from step S101 to step S103 described above, it is assumed that the user does not possess his/her own 3D avatar. If the user already possesses his/her own 3D avatar, server 20 may, for example, acquire 3D data that represents the 3D avatar directly from the user via user terminal 40.

At step S104, server 20 records the acquired 3D data that represents the user's 3D avatar in a database (which is stored in storing means 18). In this example, storing means 18 stores and manages the data of each of a user together with the 3D data representing the 3D avatar (not shown in the figures).

At step S105, server 20 receives instructions to generate content from the user via 3D scanner 10. In this example, the instructions are for generating content that includes the 3D avatar and the virtual space. The instructions also include an instruction to change the position, posture, or movement of the 3D avatar, to change the viewpoint of the virtual space, to respond to manufactured objects, and/or to generate and combine content components additional to the 3D avatar and the virtual space. In this example, the user can generate content by, for example, combining content components predetermined by the system. In this example, the content includes the 3D avatar and the virtual space. The content is described below.

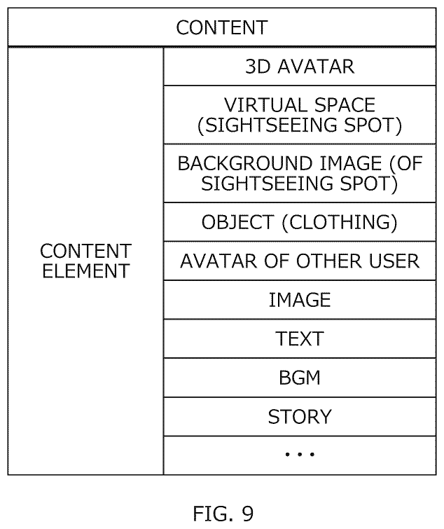

FIG. 9 is a diagram illustrative of content. FIG. 9 shows a list of examples of content components. In this example, the content components include the 3D avatar, the virtual space (e.g., a virtual sightseeing spot), backgrounds (e.g., images of the sightseeing spot), objects (e.g., clothing), 3D avatars of other users, other images, text, background music, and stories. In this example, the content components include, for example, photos/background images obtained at the sightseeing spot, and locality-specific objects. Users can combine these content components to generate personalized content for enjoyment of memories at the sightseeing spot.

Description is not made with reference given to FIG. 8. At step S106, server 20 generates the content. In this example, second generating means 14 generates the content based on the instructions received from the user at step S105. In this way the user is able to generate a wide variety of content, for example, by combining photos/background images of the sightseeing objects specific to the sightseeing spot. The content generation process at step S106 can also be applied when products are manufactured in advance (will be described in section 2-2).

Generating content includes, for example, a process of specifying an appearance of a 3D avatar when manufacturing a product. In this example, the appearance of the 3D avatar includes the posture and movement of the 3D avatar, or the position of the virtual camera in the virtual space, i.e., the angle of view of the 3D avatar. More specifically, for example, if the product to be manufactured includes a lenticular sheet, the system and/or the user can adjust a position of an image on the lenticular sheet. In this example, the user can designate the posture and movement of the 3D avatar in the image, as well as the position and angle of view of the virtual camera that captures images of the 3D avatar. The system can be used to prepare options for these designations in advance and present them to the user. As described above, information processing system 1 can generate content, and in a case that a lenticular sheet is to be used such that a picture changes when the angle is changed, the content designates multiple (two) images (e.g., a different posture and camera position) before and after the change, for example, Although the above description is given for an example in which the manufactured product is a lenticular sheet, the information processing system 1 can generate the content in the same way for a crystal etching or other manufactured products, including an adjusted posture and camera position. As described above, a user can generate content for various kinds of manufactured products.

At step S107, server 20 records the generated content in the database. In this example, storing means 18 records and manages the data of each user and the generated content by linking them (not shown in the figures). In this example, server 20 may output to user terminal 40 content recorded in the database in response to a user request (not shown in the figures).

As described above, information-processing system 1 can generate a variety of content, including 3D avatars of users. The system enables a user to generate content such as their own 3D avatar posture or movement the virtual space of the sightseeing spot. Thus, the user is able to record memories of a sightseeing spot. The use of content and the manufacture of products will now be described.

### 2-2. Use of Content and Manufacture of Products

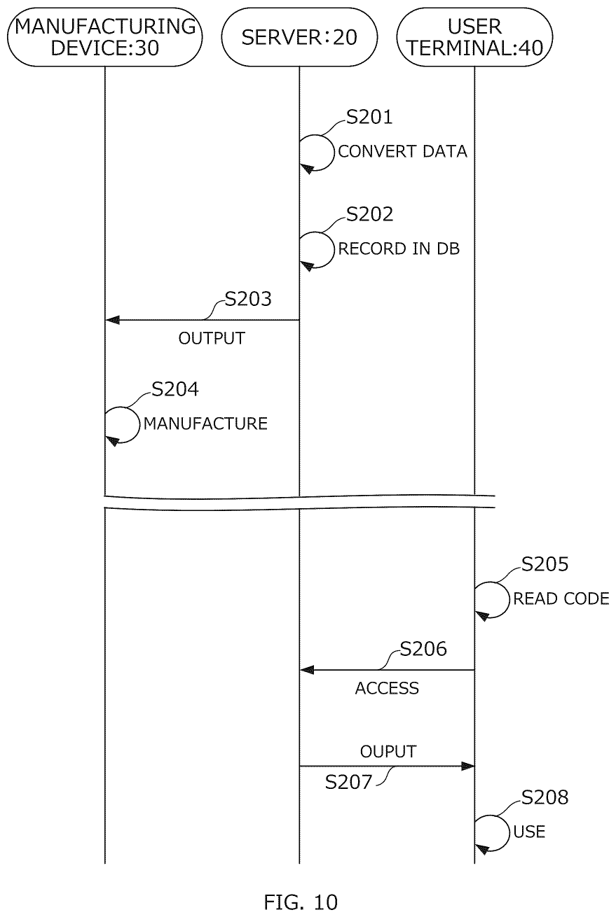

FIG. 10 is a sequence chart illustrating in information-processing system 1 content use and product manufacture. Here, it is supposed that the user or a system uses in information-processing system 1 content generated at the sightseeing spot. At step S201, server 20 executes the process for converting the generated content data, described in section 2-1, into two types of data: data for use in the virtual space (hereinafter, “virtual space data”) and data for use in manufacturing products to be used in the real space (hereinafter, “manufacturing data.”) In addition to these types of data, server 20 also generates “image code data” for use in accessing the data for the virtual space. Each type of data will is described below.

At step S202, server 20 records the converted data in the database. As described above, server 20 can generate “virtual space data,” “manufacturing data,” and “image code data” as data for processing content.

At step S203, server 20 outputs to manufacturing device 30 manufacturing data to manufacture a product as content for use in the real space. In this example, second outputting means 162 outputs to manufacturing device 30 the generated “manufacturing data.” Next, description is given with reference to a specific example of a manufactured product.

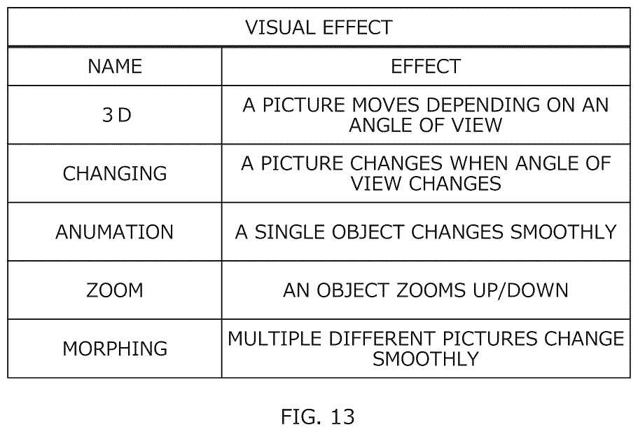

In a case that the product manufactured by manufacturing device 30 includes a lenticular sheet, second outputting means 162 outputs data to manufacturing device 30 to form on the lenticular sheets an image showing content. Here, the content is, for example, a composite image of a posture of the 3D avatar of the user and a background image of the sightseeing spot. This composite image may be formed from multiple images depending on a visual effect of the lenticular sheet desired by the user. Visual effects of the lenticular sheet are described below with reference to FIG. 13.

At step S203, second outputting means 162 outputs “data for image code” to manufacturing device 30 to form an image code on a manufactured product (e.g., a lenticular sheet) to enable access to the content in the virtual space. In this example, the image code includes, for example, a QR code (Registered trademark). The image code also includes data representing access information. The access information is, for example, a URL (Uniform Resource Locator) for the content. When this data is formed as image code on the manufactured product, the user can use the image code in the real space to access content in the virtual space. The image code data may be output together with the content data, or may be output separately.

At step S204, manufacturing device 30 manufactures a product based on the output data. A manufactured product may be, for example, a stereoscopic sheet, figurine, crystal etching (crystal glass), pendants and bookmarks. The term “manufacture” generally refers to operations used in manufacturing a product that contains content. Alternatively, “manufacture” may refer to operations for forming an image code on the manufactured product for access of content. Thus, in a case that the manufactured product is a stereoscopic sheet, the manufacturing device 30 at step S204 can form, on the stereoscopic sheet, (image) content or an image code to access the content. It is of note that at step S204, manufacturing device 30 controls the printing unit, modelling unit, and processing unit, etc., (each of which is an example of an element of generating device 305) to manufacture products as described above. Next, description of a manufactured product is provided.

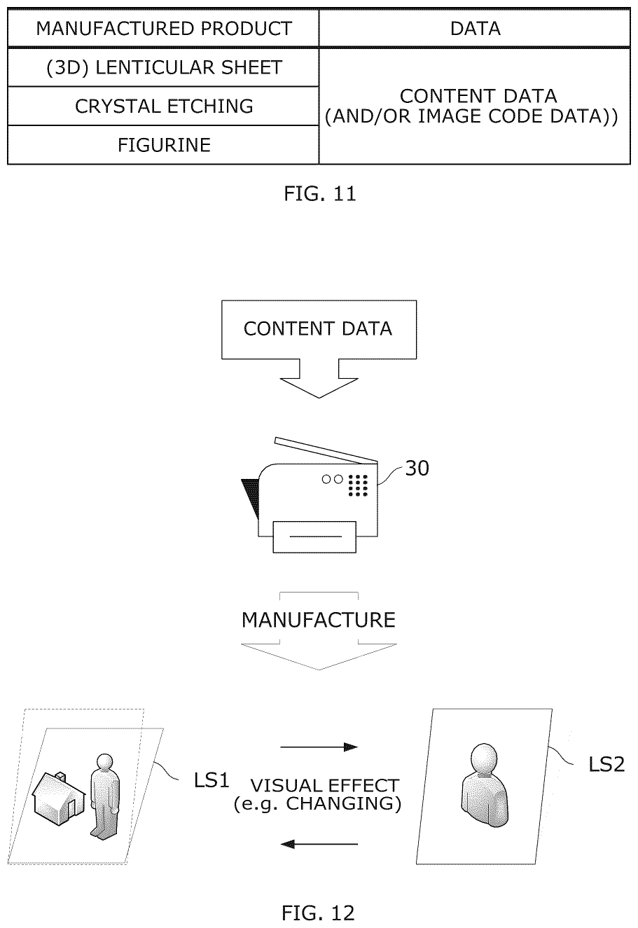

FIG. 11 shows an example of a manufactured product. More specifically, FIG. 11 shows correspondences between specific examples of manufactured products and the data content in the manufactured products. The manufactured products include, for example, a stereoscopic sheet, a crystal etching, and a figurine, and the content data of these manufactured products includes, for example, manufacturing data and/or data for image code data. A general concept of operations in a case in which the manufactured product is a stereoscopic sheet will now be explained.

FIG. 12 is a conceptual diagram illustrating the production and use of a lenticular sheet. Content data is output to manufacturing device 30 at step S203, and manufacturing device 30 forms, at step S204, an image showing the content on a lenticular sheet. In this example, images LS1 and LS2 are images that are visible on the same single lenticular sheet. In this example, image LS1 represents one state of a changing image of the lenticular sheet, and image LS2 represents another state of the changing image. The changing image is caused by visual effects of the lenticular sheet, e.g., changing the image by changing the viewing angle. In other words, manufacturing device 30 can produce a wide variety of images on lenticular sheets that enable visual effects. FIG. 12 merely shows a conceptual representation of visual effects of a lenticular sheet. In this example, the dashed line in the figure denotes an image state before and after an angle of the lenticular sheet is changed. Next, a visual effect of the lenticular sheet will be further described.

FIG. 13 shows a list of visual effects provided by lenticular sheets. The visual effects in this example include, for example, 3D (a picture moves depending on an angle of view), change (a picture changes when angle of view changes), animation (a single object changes smoothly), zoom (an object zooms up/down), and morphing (multiple different pictures change smoothly). Content may be generated based on these visual effects. Alternatively, a lenticular sheet with various visual effects may be employed depending on the generated content. As described above, manufacturing device 30 can produce a wide variety of souvenirs for users at a wide variety of sightseeing spots.

In the following description, FIG. 10 is referred to again. At step S205, user terminal 40 reads the image code. In this example, user terminal 40 uses a camera, installed on user terminal 40 such as a smartphone, to read the image code formed on the manufactured product manufactured at step S204 in order to access server 20 and obtain data for the virtual space. The processing from step S201 to step S204 and the processing after step S205 may be performed in different timelines.

At step S206, user terminal 40 uses the read image code to access server 20. In this example, server 20 can identify which user requests data for the virtual space based on the access information from user terminal 40.

At step S207, server 20 outputs data for the virtual space to user terminal 40. In this example, first outputting means 161 outputs data to user terminal 40 for use of content in the virtual space.

At step S208, the user uses the data output from server 20 via user terminal 40. Here, “use” refers to, for example, a user operation via user terminal 40. More specifically, the operation may be an operation to play content data, i.e., look back on memories, or to share content data, i.e., share data with his/her friends. As described above, information-processing system 1 can provide users with a service using various types of 3D data that combine virtual and real space.

### 2-3. Deviation Detection in Lenticular Sheet

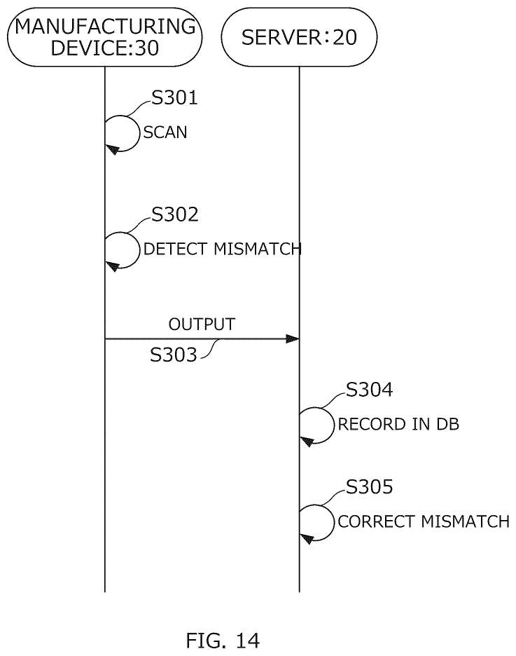

FIG. 14 is a sequence chart illustrating the error detection process for a lenticular sheet in information processing system 1. Here, description will be given in relation to an example of an operation to manage physical errors that occur in the lenticular sheet (an example of a manufactured product) produced by the manufacturing device 30. In this example, the error in lenticular sheet includes, for example, an error in dimensions of the multiple lenticular lenses that comprise the lenticular sheet. If the errors in the lenticular lenses are excessive, sufficient quality of the manufactured product cannot be provided due to a mismatch between an optimal dimension and an actual dimension of the lenticular lenses. Information-processing system 1 manages this problem by detecting errors in the lenticular sheet and adjusting content responsive to the errors. At step S301, manufacturing device 30 scans the lenticular sheet to detect errors. In this example, the lenticular sheet is scanned by scanner device 308.

At step S302, manufacturing device 30 detects errors in the scanned lenticular sheet. Specifically, manufacturing device 30 detects errors in the dimensions of the lenticular lenses. Description of errors in the lenticular lenses will now be given.

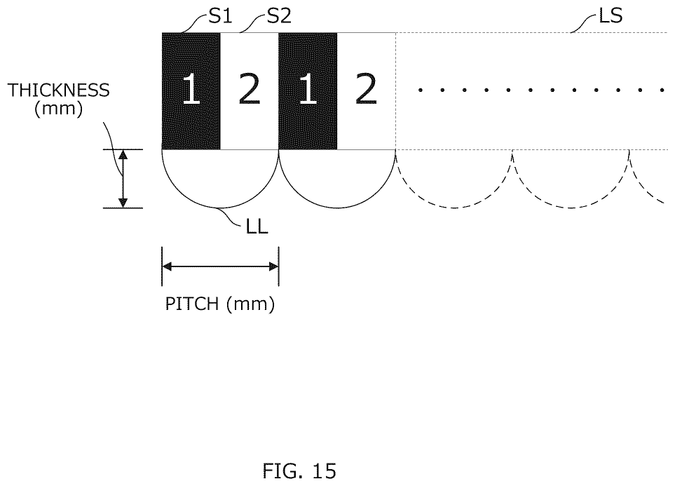

FIG. 15 is a schematic representation of a structure of a plurality of lenticular lenses comprising a lenticular sheet. In this example, lenticular sheet LS is a general-purpose lenticular sheet, and includes lenticular lens LL and screens (print surfaces) S1 and S2. In this example, the lenticular lens LL is a lens that has a cross-section of a hemispherical shape (represented as a semicircle in the drawing). Each of the lenses has dimensions for a lens pitch [mm] and a lens thickness [mm]. A viewer is able to view a 3D image in the lenticular lenses via parallax created by differences in a direction in which an object is seen from different viewpoints. The visual effects described in section 2-2 are an application of this principle. The error in the lenticular lens LL is, for example, an error in the length of the lens pitch and/or the lens thickness. Alternatively, the error may be related to strain of the shape of the lens, i.e., distortion from the semicircular shape, for example. The mismatch between the image size and the lens size can be improved by modifying the size of the image formed on areas S1 and S2 in response to the detected error in on the lenticular lenses LL.

Description will now be made with reference to FIG. 14 again. At step S303 manufacturing device 30 outputs to server 20, data that represents detected errors in the lenticular sheet. Thus, server 20 acquires error information for each portion of the lenticular sheet.

At step S304 server 20 records the acquired data in the database. The database that records the lenticular sheet error information is described below.

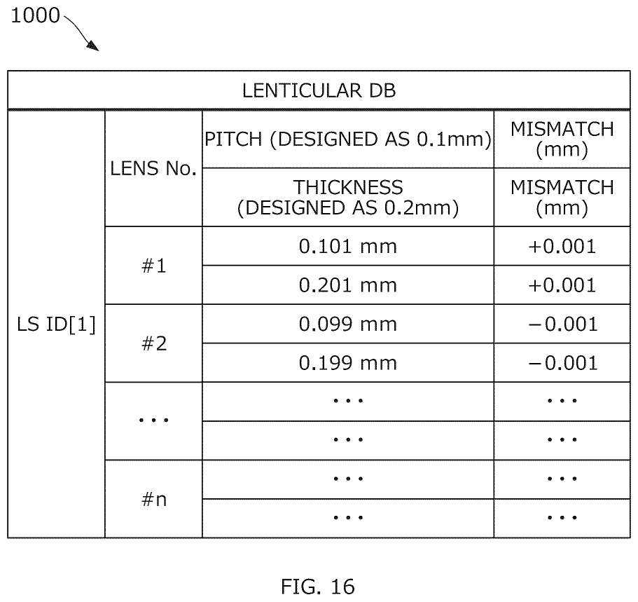

FIG. 16 shows an example of a lenticular sheet database. In this example, the Lenticular Sheet Database 1000 records the error information for multiple lenticular lenses namely, for each lens that comprises a lenticular sheet. Each lenticular sheet can be identified by use of a sheet ID. In this example, the error information includes, for example, a difference between a length of an actual lens pitch and its standard (or designed pitch), and a difference between the length of the actual lens thickness and its standard (or designed thickness). As described above, server 20 is able to use the error information to modify the content.

Description will now be made with further reference to FIG. 14 again. At step S305 server 20 performs a mismatch correction process with respect to content to be formed as an image on the lenticular sheet using the error information in the lenticular sheet database 1000. The mismatch correction process in this example includes, for example, modifying the content formed as an image on the print surface in accordance with the error in the lenticular lenses. More specifically, server 20 modifies an image size of the content formed on areas S1 and S2. The modified content is recorded in the database. Alternatively, the modified content may be output as data to manufacturing device 30. Manufacturing device 30 is thus able to produce a lenticular sheet with improved mismatch based on the output content data.

### 3. Modifications

The invention is not limited to the embodiments described above, and various modifications can be implemented. Some modifications will be described below. Two or more of the modifications described below may be combined.

### (1) Information Processing System 1

Hardware and network configurations in information processing system 1 are not limited to the examples described in the embodiment. Information processing system 1 may have any hardware and network configuration as long as information processing system 1 is able to implement its functions. For example, multiple physical devices may operate together as information processing system 1. The configuration and system structure shown in FIG. 1 is an example, only, and merely shows an overview of the system. For example, manufacturing device 30 may be a device in a manufacturing facility that is used by an organization providing services at a sightseeing spot, and its operation may be managed by a system different from information processing system 1. Information processing system 1 may have at least one processor and a memory operably connected to the at least one processor.

### (2) 3D Scanner 10

3D scanner 10 is not limited to the examples described in the embodiment. 3D scanner 10 may acquire body composition data or blood analysis data of the user, as well as acquiring images of the user. In other words, 3D scanner 10 may acquire data such as temperature, blood pressure, weight, body fat, and pulse rate, as well as a physical appearance of the subject, with various sensors installed beforehand/afterwards. This data may be used to generate a 3D avatar.

### (3) Server 20

Server 20 is not limited to the example described in the embodiment. A part of the functions in server 20 may be implemented on another server device; for example, on a physical server or a virtual server (including cloud computing). A correspondence between software and hardware elements is not limited to the examples described in the embodiment. For example, at least a part of the functions described in the embodiments as being implemented in server 20 may be implemented in another device or system, or at least a part of the functions described as being implemented in other devices or systems may be implemented in server 20. For example, server 20 may be integrated with manufacturing device 30. In this case, manufacturing device 30 may modify the content using the data of the manufactured product.

### (4) Manufacturing Device 30

Manufacturing device 30 is not limited to the examples described in the embodiment. For example, manufacturing device 30 may produce other products, such as a postcard, a bookmark, or a pendant, in addition to the manufactured products described in the embodiment. The data for the manufactured products may include at least one of data for content and data for an image code to access the content.

### (5) User Terminal 40

The user terminal 40 is not limited to the examples described in the embodiment. For example, a user of user terminal 40 may use information processing system 1 via other of their own terminals; and user terminal 40 or other terminals may be equipped with various kind of user interfaces (UIs) such as display screens and input devices.

### (6) Content Generation

The sequence chart shown in FIG. 8 is merely an example of an operation of information processing system 1. Some of the illustrated processes may be omitted, the order of the processes may be changes, or new steps/processes may be added. For example, at step S103, in addition to the process of server 20 acquiring 3D data from 3D scanner 10, user terminal 40 may acquire 3D data.

In addition, server 20 may accept at step S105 any instruction relating to the content. The instructions may be instructions relating to a plurality of content, for example. The instructions may include an instruction to form a composite of a plurality of content, for example. In addition, the instructions may be selected from among a plurality of preset instructions, and the receiving means 13 may receive the selected instructions. The user may input to server 20 the instructions to generate content via user terminal 40 instead of via 3D scanner 10.

### (7) Using Content and Manufacturing Products

The sequence chart shown in FIG. 10 is merely an example of the operation in information processing system 1. A part of the illustrated steps/processes may be omitted, order may be changed, or new steps/processes may be added. Manufacturing device 30 may be a relatively simple device that is installed at a store at a sightseeing spot, or may be a complex device installed at a factory at a location remote to the sightseeing spot. The series of operations may be performed in real time or may be triggered when data is output from server 20 to manufacturing device 30.

For example, at step S205, user terminal 40 may use any known technical means to access server 20, rather than reading the image code on the product. For example, user terminal 40 may acquire data for the virtual space by installing and using an application, etc., which is configured to operate with server 20.

### (8) Error Detection in Lenticular Sheet

The sequence chart shown in FIG. 14 is merely an example of operations in information processing system 1. Some of the illustrated steps/processes may be omitted, the order may be changed, or new steps/processes may be added. In this example, the error detection process described in Section 2-3 is not intended for use with respect to lenticular sheets only. The methods described above may be applied to a wide variety of manufactured products. In the case of manufacturing device 30 performing error detection in manufactured products, at step S301 to step S302, manufacturing device 30 may perform the error detection via any known technical means. For example, any device capable of error detection, and not limited to scanner device 308, may be implemented in manufacturing device 30.

### (9) 3D Avatar

3D avatars are not limited to the examples described in the embodiment. For example, the 3D avatar may be an avatar that reproduces the user as he/she is. Alternatively, the 3D avatar may not be exactly the same as the user. The 3D avatar may be a 3D model that has been modified/revised, or the 3D avatar may be a morphed 3D model. Alternatively, the 3D avatar may be a cartoon or animation character. The 3D avatar may comprise meshes and polygons.

### (10) Content and Content Components

Content and content components are not limited to the examples described in the embodiments. The content can be any kind of content, for example, the content need not include the user's 3D avatar and the virtual space. The content components may be any kind of components, and may include predetermined programs/algorithms.

### (11) Virtual Space

The virtual space is not limited to the examples described in the embodiment. For example, the virtual space may be a metaverse in which a sightseeing spot is reproduced, or the virtual space may be a fantasy space in which objects are scaled up/down, or represented using animation/morphing. In addition to or instead of sightseeing spots, the virtual space may be created based above ground, underwater, underground, on other planets, or in outer space.

### (12) Manufactured Products

Manufactured products are not limited to the examples described in the embodiments. For example, the manufactured product may be a food item, clothing, stationery, or a painting. The manufactured product may also include semi-finished product, or a part of the whole product.

### (13) Database

Database in information processing system 1 is not limited to the examples described in the embodiment. Any data can be recorded in the database. For example, instruction data may be recorded in addition to 3D data and content data. Alternatively, manufactured product data may be recorded into the database. The data structure in the database is not limited to the examples shown in the figures. The data of the content output by first outputting means 161 and second outputting means 162 may be any data of content recorded in the database, or at least a part of the content. Furthermore, any data format may be used.

### (14) Use Case

Information processing system 1 is not limited to the example described for use a sightseeing spot. For example, information-processing system 1 may be used to advertise a television program or a movie or to promote sale of related merchandise.

### (15) AI

With respect to the configuration and operation illustrated in the embodiments, AI and/or machine learning functions may be implemented in information processing system 1. With respect to implementation of AI in information processing system 1 in this example, for example, content generation may be controlled by AI. AI may optimize content generation in accordance with predetermined manufacture.

### (16) Blockchain

With respect to the configuration and operation described in the embodiment, blockchain technology may be applied to information processing system 1. With respect to the application of blockchain technology in information processing system 1, for example, data registered in a database may be recorded in the blockchain network. Accordingly, various types of data can be protected, e.g., a history of content generation can be protected from being deleted or rewritten. Any data may be recorded in the blockchain network.

### (17) Other Modifications

Programs executed by CPU 101, CPU 201, CPU 301, or CPU 401 may be provided by being downloaded over a network such as the Internet, or may be provided by being pre-recorded on a computer-readable non-transitory recording medium such as a DVD-ROM. Each processor may be a Micro Processing Unit (MPU) or a Graphics Processing Unit (GPU) instead of a CPU.

What is claimed is:

1. An information processing system comprising:
at least one processor; and
a memory operably connected to the at least one processor, wherein
the at least one processor is configured to:
acquire an image of a user;
generate a 3D avatar from the acquired image;
receive an instruction to generate content including the 3D avatar and a virtual space;
generate the content in response to the instruction;
convert the content into data for use in the virtual space, and data for manufacturing products for use in a real space;
output data for use of the content in the virtual space; and
output data to a device that manufactures the products for use in the real space.

2. The information processing system according to claim 1, wherein
the instructions include an instruction to change a position, posture, or movement of the 3D avatar.

3. The information processing system according to claim 1, wherein
the instructions include an instruction to change a viewpoint in the virtual space.

4. The information processing system according to claim 1, wherein
the instructions include an instruction to include in the content, at least one content component that is additional to the 3D avatar and the virtual space.

5. The information processing system according to claim 4, wherein
the additional content component includes background images, objects, or a 3D avatar of another user.

6. The information processing system according to claim 1, wherein
the manufactured product includes a lenticular sheet on which an image showing the generated content is formed, and
the at least one processor is further configured to output to the device the data for forming on the lenticular sheet the image showing the generated content.

7. The information processing system according to any one of claim 1, wherein
the at least one processor is further configured to output to the device data to form on the manufactured product image code for accessing the content in the virtual space.

8. The information processing system according to claim 1, wherein the at least one processor is further configured to
modify the content in accordance with error information for the manufactured product, the error information being input from the device.

9. An information processing method comprising:
acquiring an image of a user;
generating a 3D avatar from the acquired image;
receiving an instruction to generate content including the 3D avatar and a virtual space;
generating the content in response to the instruction;
converting the content into data for use in the virtual space and into data for manufacturing products for use in a real space;
outputting data for use of the content in the virtual space; and
outputting data to a device that manufactures products for use of the content in the real space.

10. A computer-readable non-transitory storage medium for storing a program that causes a computer to execute a process, the process comprising:
acquiring an image of a user;
generating a 3D avatar from the image;
receiving an instruction to generate content including the 3D avatar and a virtual space;
generating the content in response to the instruction;
converting the content into data for use in the virtual space and data for manufacturing products for use in a real space;
outputting data for use of the content in the virtual space; and
outputting data to a device that manufactures the products for use of the content in the real space.
